(19) United States
(12) Patent Application Publication
(10) Pub. No.: US 2019/0141152 A1
(43) Pub. Date: May 9, 2019

(54) WEB PUSH NOTIFICATIONS IN THE BACKGROUND

(71) Applicant: Microsoft Technology Licensing, LLC, Redmond, WA (US)

(72) Inventors: Ali ALABBAS, Sammamish, WA (US); Steven J. BECKER, Bellevue, WA (US)

(21) Appl. No.: 15/807,469

(22) Filed: Nov. 8, 2017

(51) Int. Cl. H04L 29/08; G06F 9/445; G06F 9/50

(52) U.S. Cl. CPC H04L 67/26; H04L 67/02; G06F 9/5038; G06F 9/445

(57) ABSTRACT

Techniques for processing push messages are described. When a client device receives a push message, the operating system can activate an operating system level (OS-level) task to process the push message. The OS-level task can launch an application level process to handle the push notification or buffer the push notification based on an assessment of system resources used by processes executing on the client device.

### BACKGROUND

Push notifications are messages that come from an application or website; where the request for a given message is initiated by the application or website. The messages can be made to appear on the user's desktop or device, even when they are not using the application or visiting the website. One form of push technology is sometimes referred to as a “native” push, in which an application is provided (e.g., downloaded) on a user's device (e.g., laptop, mobile device, etc.). The application can interact with servers over a network such as the Internet to deliver messages to the user.

Another kind of push technology is referred to as “web” push, in which push notifications can originate from a website or other web application. Web push allows a user visiting a website to opt-in and receive notifications from that website, without requiring any applications to be downloaded or otherwise installed on the user's device. The user simply clicks on a link on the website's webpage to authorize and enable web push notifications.

### SUMMARY

Handling web push messages in accordance with the present disclosure can include sending a web push message to a client device. The received push message can be provided to an operating system level (OS-level) task executing in the process space of the operating system of the client device. The OS-level task can make an assessment whether to launch an application-level process to handle the push message (e.g., generate a notification) or to buffer the push message.

In accordance with the present disclosure, the assessment can be based on the utilization of system resources on the client device. In other embodiments, the assessment can be based on one or more policies.

In accordance with the present disclosure, the client device can subscribe to receive push notifications using a web application that is different from the application-level process launched by the OS-level task to handle the push message.

In accordance with the present disclosure, the OS-level task can buffer the received push message and later launch an application-level process to process the buffered push message.

The following detailed description and accompanying drawings provide further understanding of the nature and advantages of the present disclosure.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts a simplified block diagram of a system environment according to certain embodiments.

FIG. 2 shows a computing device in accordance with some embodiments.

FIGS. 3 and 4 illustrate the process of subscribing to receive push messages.

FIGS. 5, 6A, 6B illustrate the process of handling push messages in accordance with the present disclosure.

FIG. 7 shows conventional handling of push messages.

### DETAILED DESCRIPTION

Conventional techniques for handling web push notifications use application-level processes from the outset, for example, via a web browser or a child process (sometimes referred to as a service worker) launched by the web browser. By contrast, embodiments in accordance with the present disclosure receive and initially process web push notifications with OS-level background tasks in the operating system (OS) of the client device. Using an OS-level task to handle web push notifications obviates the need for a constantly active web application process to receive and handle an incoming web push notification. An OS-level task can take into account the available resources of the client device such as process load and memory/storage usage when processing a web push notification, whereas application-level processes are typically restricted from having access to such system-wide information.

Web push notifications processed in accordance with the present disclosure can be prioritized with respect to every other process running on the client device to ensure that the processing of web push notifications does not upset the proper and balanced use of OS resources. Embodiments in accordance with the present disclosure can therefore significantly improve performance of the computing device in terms of performance and reliability. This can be especially significant in mobile devices, where battery capacity is a constant concern. Eliminating the need for an active web application to handle web push notifications can help to preserve battery life in a mobile device that uses web push notifications.

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein.

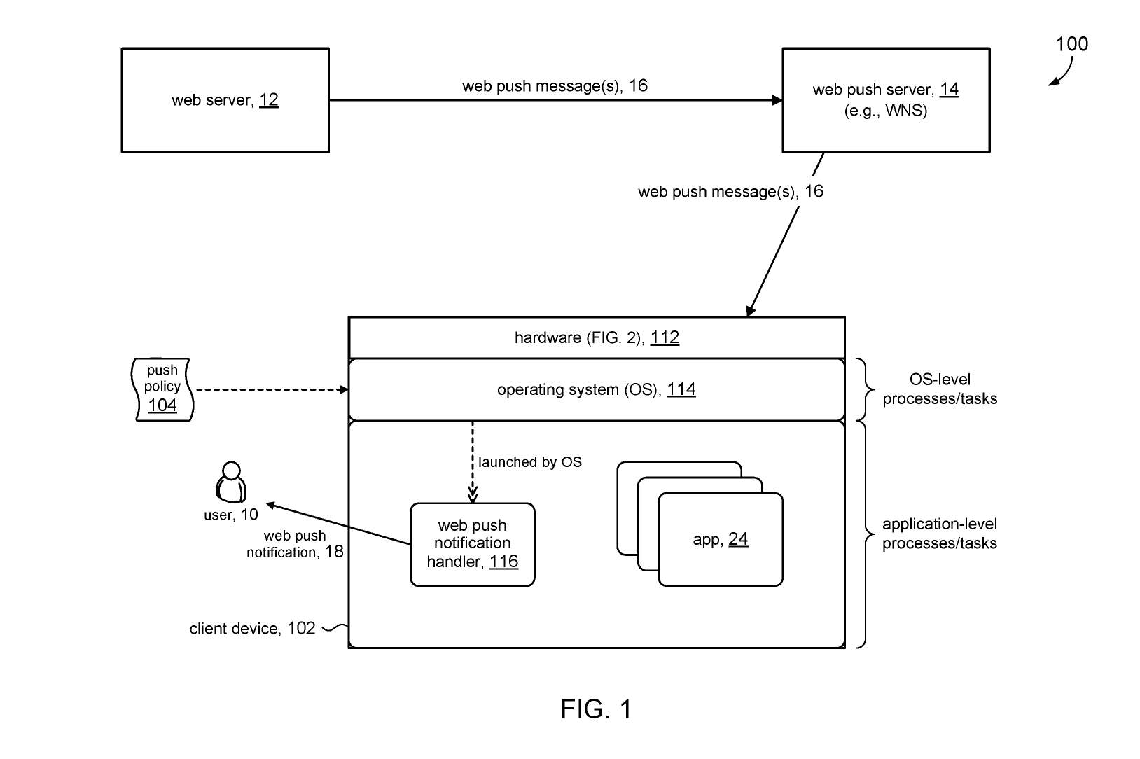

FIG. 1 illustrates an example of a system 100 for processing web push notifications in accordance with the present disclosure. In some embodiments, the system 100 can include a web server 12 configured to provide web push messages (notifications) 16 to a web push server 14. A web push message 16 is a message initiated by the web server 12 for delivery to a web application executing on the client device 102. The present disclosure will use the phrases “push message” and “push notification” interchangeably.

A web application refers to an application implemented using web technologies that execute within the context of a web runtime environment such as a web browser. The term “web technologies” refers to languages and multimedia packages that are used in conjunction with each other to produce dynamic web sites. Languages for web sites include hypertext mark-up language (HTML), dynamic HTML (DHTML), JavaScript, cascading style sheets (CSS), and the like. Multimedia packages include the Adobe Flash® multimedia platform and the scalable vector graphics (SVG) platform.

In various embodiments, the web server 12 can be any entity that provides web-based content and/or web-based services. For example, the web server 12 can be a website, a web application host, a mobile application host, a cloud-based service, and in general can be any web application implemented using web technology.

The web push server 14 can be any entity that enables the delivery of push messages 16. The Microsoft® Windows Push Notification Services (WNS) is an example of a web push server.

The system 100 can include a client device 102 that receives push messages 16 from web server 12. In some embodiments, the client device 102 can comprise hardware 112 that comprise the device, and an operating system (OS) 114 that supports the basic functions of the device, such as scheduling tasks, executing applications 24, and controlling peripherals. The operating system 114 is a process that manages the hardware 112 and all the other processes (e.g., applications 24) executing on the client device 102.

An underlying communication network (not shown) can provide communication among the web server 12, web push server 14, and client devices 102. The communication network can comprise any suitable combination of a local area network, wide area network, public switched telephone network, cellular network, and the like.

The client device 102 can be any suitable computing platform including desktop computers, laptops, and portable/handheld devices such as computer tablets, mobile communication devices and the like. The client device 102 can receive web push messages 16. In accordance with aspects of the present disclosure, and in response to receiving a web push message 16, the operating system 114 can launch a web push message handler 116 to process the web push message 16. In some embodiments, the operating system 114 can select between launching the web push message handler 116 to process the web push message 16, or in the alternative, buffer the web push message 16. In some embodiments, the operating system 114 can process a received web push message 16 in accordance with a push policy 104. These aspects to the present disclosure are discussed in more detail below.

The web push message handler 116 can present a web push notification 18 to a user 10 of the client device 102. Typically, for example, the web push notification 18 can be visually presented to the user 10; e.g., a pop-up message appearing on the display of the client device 102. In some embodiments, an audible alert can accompany the visual presentation. In other embodiments, the web push notification 18 can be a more sophisticated and interactive activity, for example, connecting to a call over the Internet, establishing a video conference, and so on.

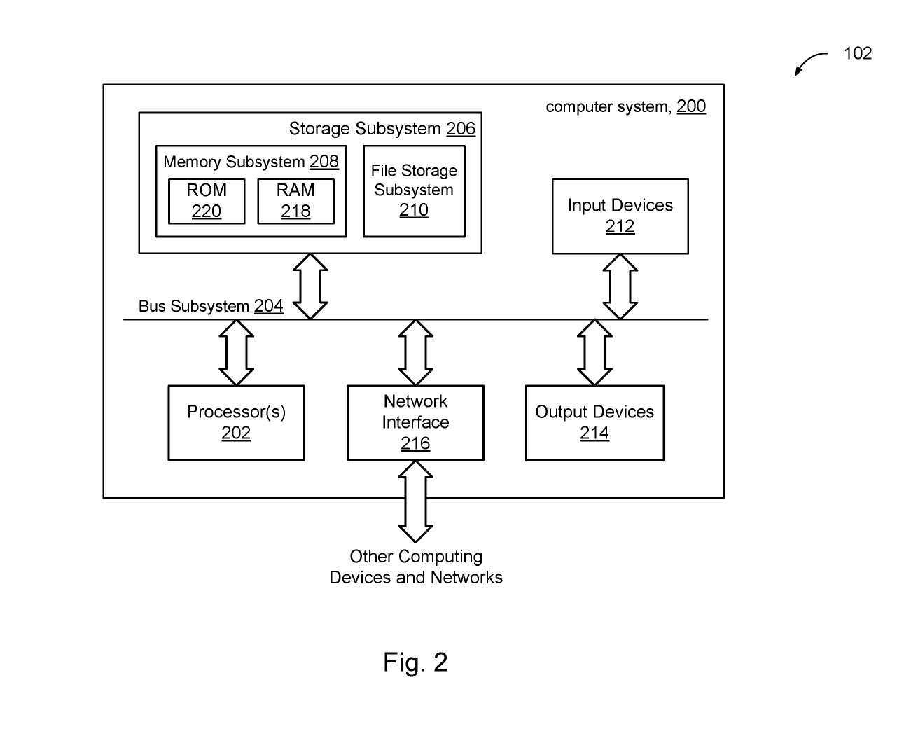

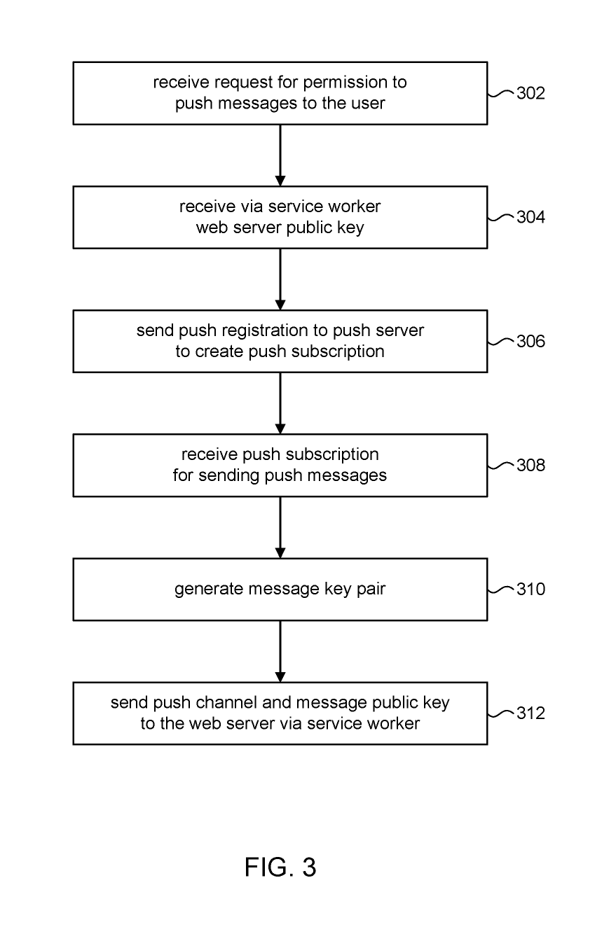

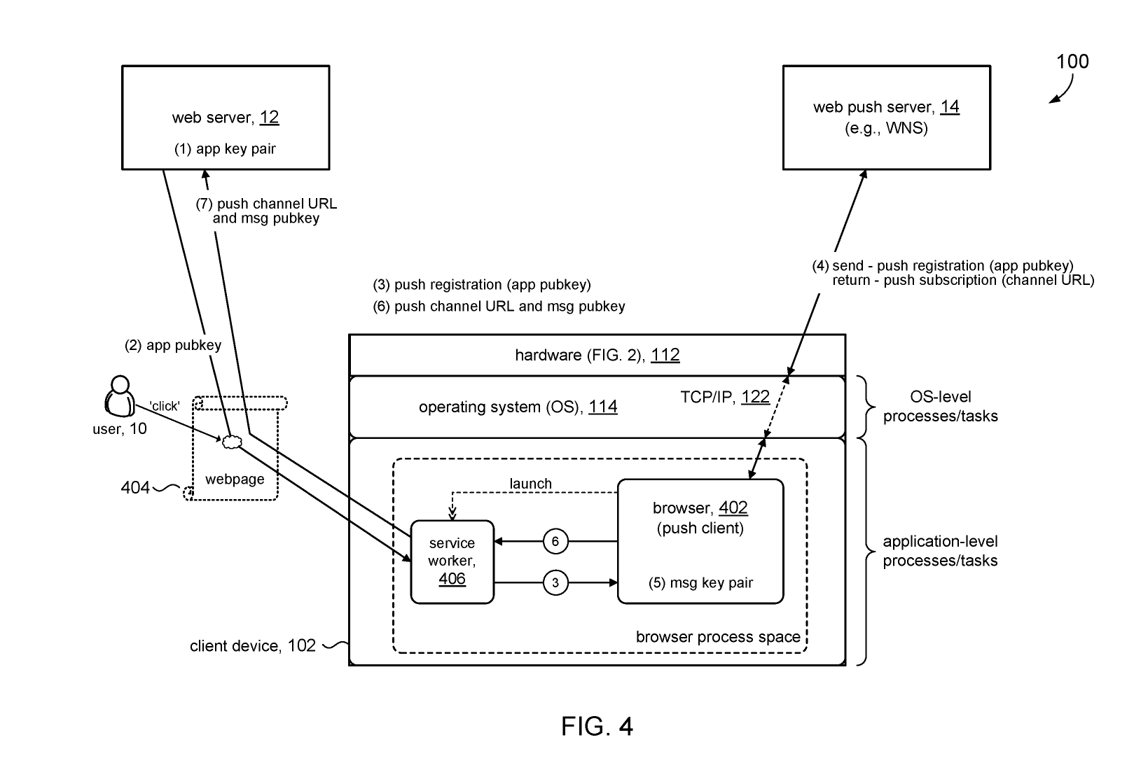

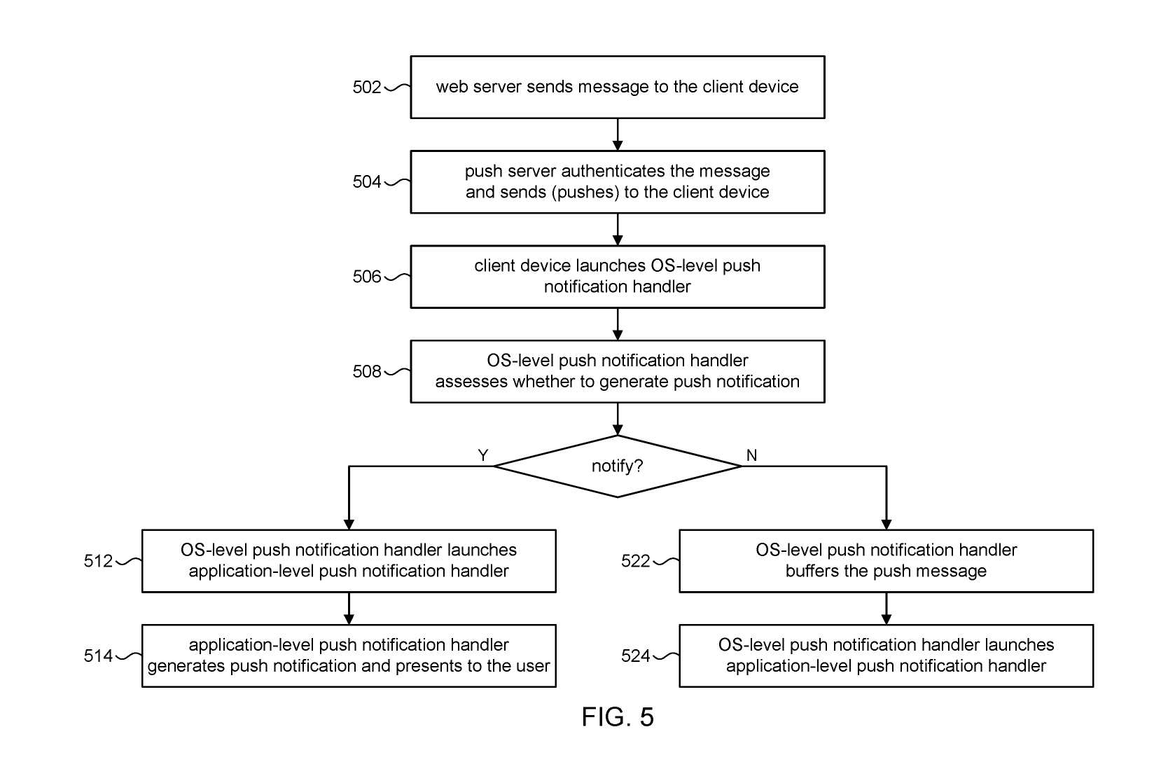

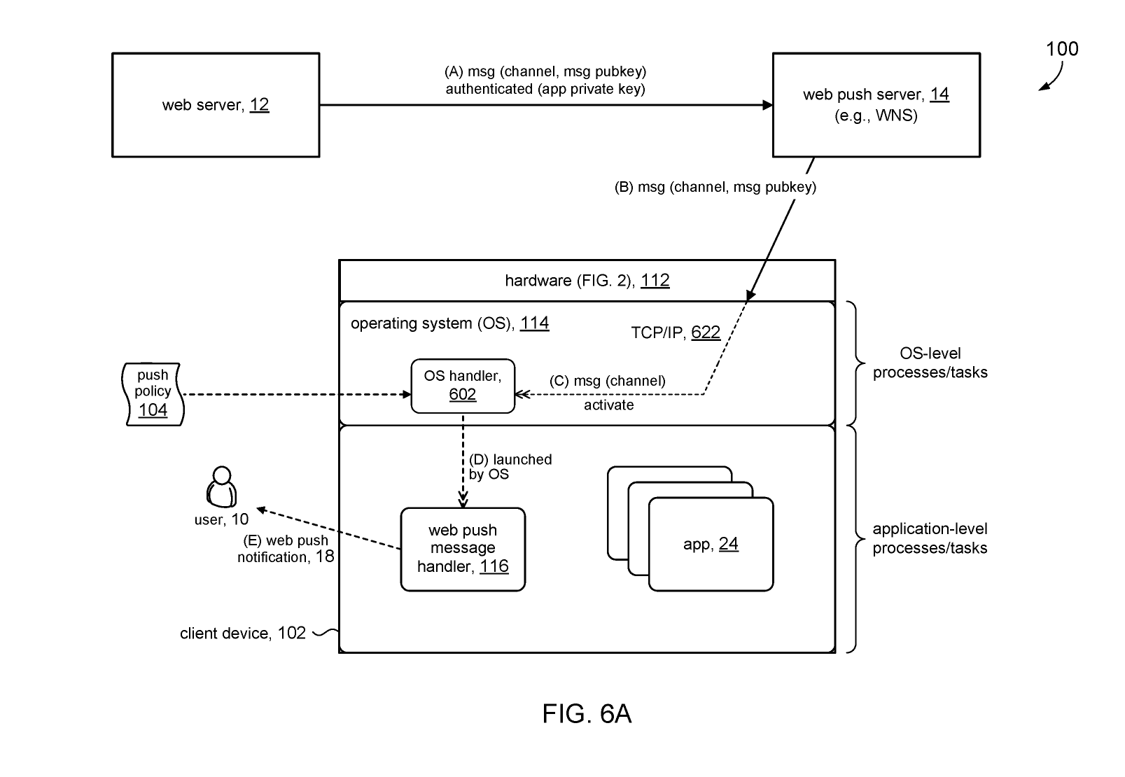

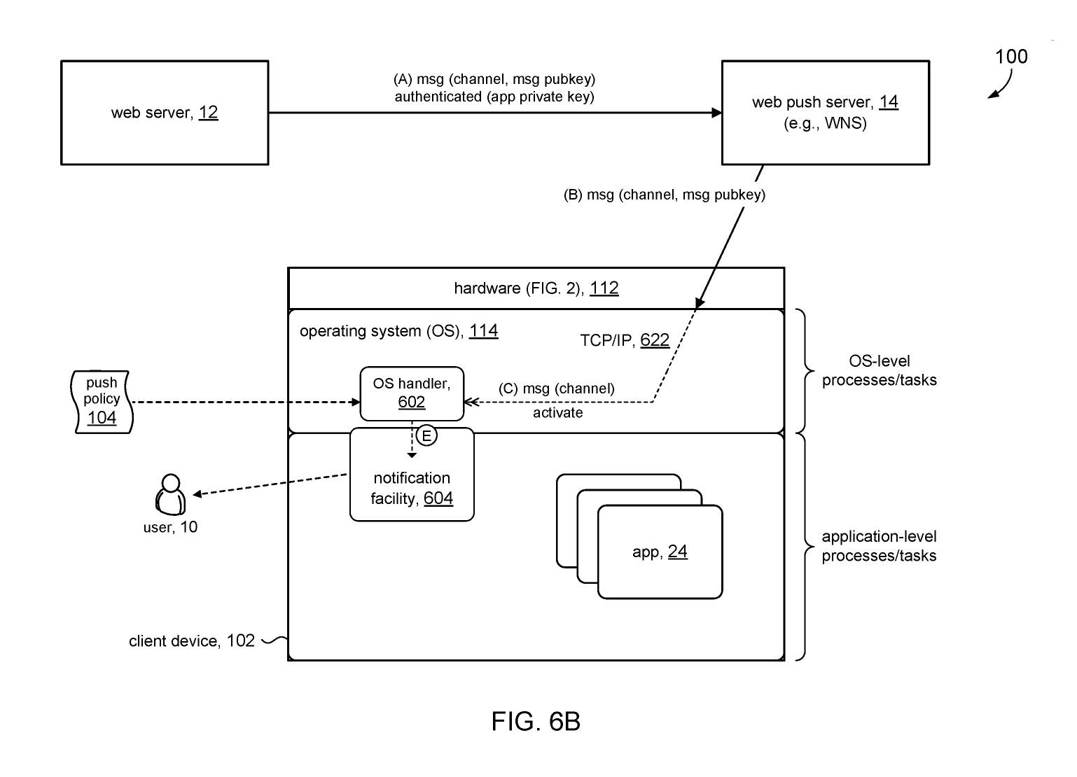

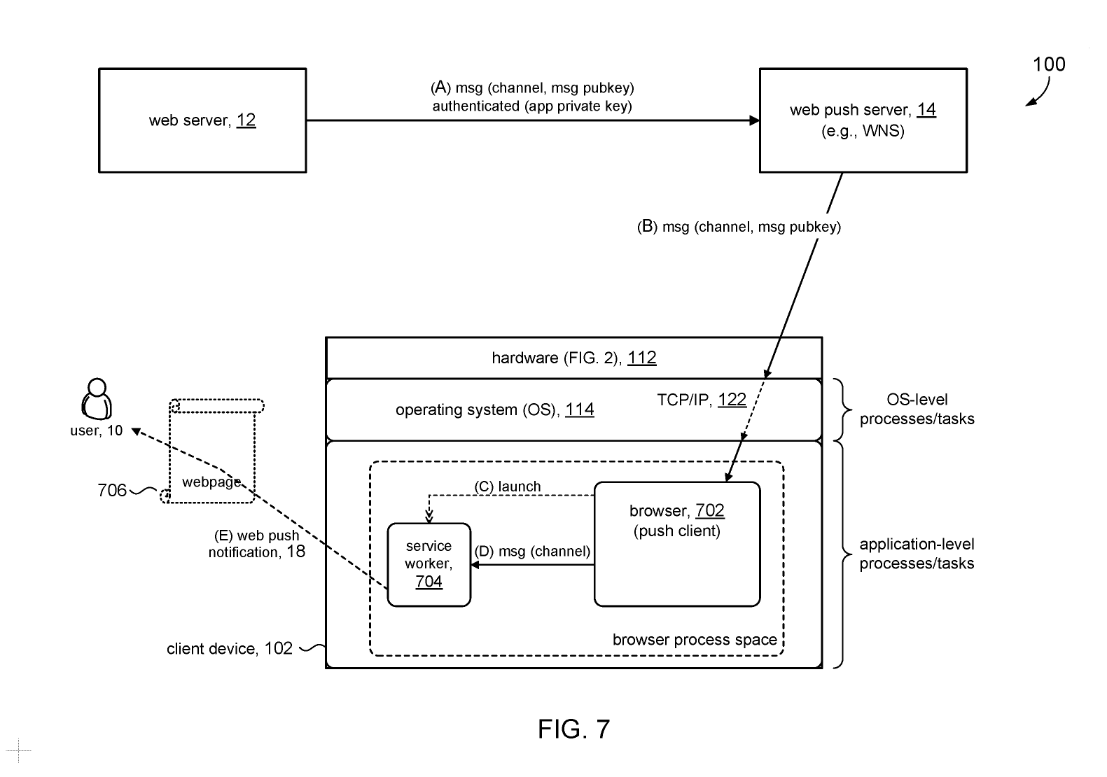

FIG. 2 depicts a simplified block diagram of an example computer system 200 according to certain embodiments. Computer system 200 can be used to implement any of the computing devices, systems, or servers described in the foregoing disclosure, including client device 102. As shown in FIG. 2, computer system 200 can include one or more processors 202 that communicate with a number of peripheral devices via a bus subsystem 204. These peripheral devices can include a storage subsystem 206 (comprising a memory subsystem 208 and a file storage subsystem 210), user interface input devices 212, user interface output devices 214, and a network interface subsystem 216.

Bus subsystem 204 can provide a mechanism for letting the various components and subsystems of computer system 200 communicate with each other as intended. Although bus subsystem 204 is shown schematically as a single bus, alternative embodiments of the bus subsystem can utilize multiple busses.

Network interface subsystem 216 can serve as an interface for communicating data between computer system 200 and other computer systems or networks. Embodiments of network interface subsystem 216 can include, e.g., an Ethernet card, a WiFi and/or cellular adapter, a modem (telephone, satellite, cable, ISDN, etc.), digital subscriber line (DSL) units, and/or the like.

User interface input devices 212 can include a keyboard, pointing devices (e.g., mouse, trackball, touchpad, etc.), a touch-screen incorporated into a display, audio input devices (e.g., voice recognition systems, microphones, etc.) and other types of input devices. In general, use of the term “input device” is intended to include all possible types of devices and mechanisms for inputting information into computer system 200.

User interface output devices 214 can include a display subsystem or non-visual displays such as audio output devices, etc. The display subsystem can be, e.g., a flat-panel device such as a liquid crystal display (LCD) or organic light-emitting diode (OLED) display. In general, use of the term “output device” is intended to include all possible types of devices and mechanisms for outputting information from computer system 200.

Storage subsystem 206 includes a memory subsystem 208 and a file/disk storage subsystem 210. Subsystems 208 and 210 represent non-transitory computer-readable storage media that can store program code and/or data that provide the functionality of embodiments of the present disclosure.

Memory subsystem 208 includes a number of memories including a main random access memory (RAM) 218 for storage of instructions and data during program execution and a read-only memory (ROM) 220 in which fixed instructions are stored. File storage subsystem 210 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 200 is illustrative and many other configurations having more or fewer components than system 200 are possible.

Referring to FIGS. 3 and 4 and other figures, in order for a web push notification from a web server 12 to reach a web application on the client device 102, the user 10 must subscribe to receive web push notifications from the web server 12 on one or more channels. For example, the World Wide Web Consortium (W3C) defines a Push API that enables the subscribing and sending of a push messages.

The discussion will now turn to a high level description of operations and processing by the client device 102 to subscribe to receive web push notifications. The client device 102 can subscribe to any number of push subscriptions with web server 12, and more generally with any web application that implements push technology. FIG. 3 illustrates operations for subscribing to receive push notifications, and FIG. 4 shows an example of data flows 1-7 through system 100 during the subscription process. In some embodiments, the client device 102 can include computer executable program code, which when executed by a processor (e.g., 202, FIG.2), can cause the client device 102 to perform processing in accordance with FIG. 3. The operation and processing blocks described below are not necessarily executed in the order shown, and can be allocated for execution among one ore more concurrently executing processes and/or threads.

At operation 302, the client device 102 can receive a request from the web server 12 for permission to push messages to user 10. Referring to FIG. 4, for example, in some embodiments the user 10 may launch a web browser process 402 to visit and interact with the web server 12 via webpage 404. More generally, however, the present disclosure is not limited to web browsers, and in other embodiments the user 10 can launch any web application (e.g., Microsoft® LinkedIn® social networking app) that executes on a web platform. References to a web browser will be understood to include any suitable web application. At some point during the interaction, the web server 12 can present a push message permission prompt on the webpage 404 to prompt the user 10 for permission to push messages to the client device 102; e.g., by “clicking” on the permission prompt. This action by the user 10 can initiate the process for creating a push subscription for receiving push messages from the web server 12 over a push channel.

At operation 304, the client device 102 can receive a web server public key from the web server 12. In some embodiments, for example, in response to the user 10 giving the web server 12 authorization to push messages to the user, the web server 12 can generate a cryptographic key pair comprising a public key and a private key (data flow 1). The web server 12 can provide the public key component (web server public key, data flow 2) to a service worker 406 that executes in the process space of the browser process 402 on the client device 102. A service worker process can execute event-driven code independently of the web page 404, and can be used to perform functions such as handling push messages, background sync operations, geofencing, and the like. In this process flow, for example, the browser process 402 can launch a service worker 406 to handle a push message. In some embodiments, the service worker 406 can be a child process that executes in the process space of the browser process 402. In other embodiments, the service worker 406 can run as a thread in the same process as the browser process 402or in a child process of the browser process. The service worker 406 can execute a service worker script (e.g., a JavaScript written by a web developer) to perform the desired functionality.

At operation 306, the client device 102 can send a push registration request to a web push server to create a push subscription. In some embodiments, for example, the service worker 406 can send a push registration request to the web push server 14 that includes the web server public key (data flows 3, 4). In some embodiments, the browser process 402 can create a TCP/IP connection 122 in the operating system 114 to communicate with the web push server 14 to send the push registration request.

At operation 308, the client device 102 can receive a push subscription from the web push server 14. In some embodiments, for example, the web push server 14 can expose a push channel that is associated with the client device 102, which the web server 12 can push messages 10 to. The push channel specifies an endpoint on the client device 102 for messages from the web server 12. The push channel can identify the particular web application (e.g., web browser 402) on the client device 102 that subscribed for the push notification. The push channel, for example, can be a specific URL or other suitable identifier that identifies the client device 102 and the specific web application. The web push server 14 can communicate a push subscription (data flow 4) that includes the push channel information to the client device 102 which, for example, can be received by the browser process 402 via the TCP/IP connection 122.

At operation 310, the client device 102 can generate a cryptographic key pair for sending and receiving messages, comprising a public key component and a private key component (data flow 5).

At operation 312, the client device 102 can send the push channel and message public key to the web server 12 (data flows 6, 7)). The steps for creating a push subscription that allows the web server 12 to push messages to the client device 102 can be deemed complete. The foregoing processing described in FIGS. 3 and 4 show a service worker 406 initiating the push subscription. This is not exclusively the case, however. While in some instances a service worker may be used to create a push notification, it will be appreciated that in other instances a website or a web-based Windows app may do this in the web page's JavaScript.

Referring to FIGS. 5, 6A, 6B, the discussion will now turn to a high level description of operations and processing by the client device 102 for receiving and handling push notifications in accordance with some embodiments of the present disclosure. FIG. 5 illustrates operations for sending push messages in addition to operations for receiving push messages, and FIGS. 6A, 6B illustrates an example data flows A-E through the system 100 during the process. In some embodiments, the client device 102 can include computer executable program code, which when executed by a processor (e.g., 202, FIG.2), can cause the client device 102 to perform processing in accordance with FIG. 5. The operation and processing blocks described below are not necessarily executed in the order shown, and can be allocated for execution among one ore more concurrently executing processes and/or threads.

At operation 502, the web server 12 can push a push message (e.g., 16, FIG. 1) to the client device 102. In some embodiments, for example, the web server 12 can encrypt the push message using the message public key received from the client device 102 during the process of creating the push subscription. The web server 12 can encrypt the encrypted message using its own private key to authenticate the web server 12 as the source of the message. The web server 12 can send the doubly-encrypted message along with a push channel that identifies the target (endpoint) of the push message to the web push server 14 in a push request (data flow A, FIG. 6A).

At operation 504, the web push server 14 can process the push request received from the web server 12. In some embodiments, the web push server 14 can authenticate the received push message to verify the source of the push message to be the web server 12. For example, the web push server 14 can use the web server public key provided to the web push server 14 during the subscription creation phase. If the received push message is not authenticated, the web push server 14 can deny the push request. Otherwise, the web push server 14 can communicate the push message to the client device 102, including the push channel to identify the target of the push message (data flow B).

At operation 506, the client device 102 can receive the push message. In accordance with some embodiments of the present disclosure, the client device 102 can launch or otherwise activate an OS-level push message handler (e.g., OS-level handler 602, FIG. 6) to process the received push message. In some embodiments, for example, the TCP/IP connection 622 in the operating system 114can respond to the received push message from the web push server 14 by launching or otherwise activating the OS-level handler 602, and provide the received message to the handler (data flow C). In accordance with the present disclosure, the OS-level handler 602 can be an OS-level process that executes within the process space of the operating system 114.

At operation 508, the client device 102 can assess whether or not to generate a push notification in response to receiving the push message. In accordance with some embodiments of the present disclosure, the assessment can be made by the OS-level handler 602 executing in the process space of the operating system 114. Generally, the OS-level handler 602 can reason whether or not processing the received push notification will have negative impact on the client device 102, such as disrupting other executing processes, reducing battery life, etc. This aspect of the present disclosure is discussed in more detail below.

In some embodiments, the OS-level handler 602 can assess how to process a received push message based on one or more policies (e.g., 104, FIG. 6A). For example, if the client device 102 is in a power save mode (e.g., due to low battery or in response to the user opting for power save mode), a policy can dictate that received push messages can be processed by buffering them (operation 522 below) instead of dispatching an event to process them (operation 512 below). If the client device 102 is in a steady state (e.g., the device is in sleep mode) where there is still an internet connection, a policy can dictate that received push messages can be buffered instead of dispatched. A policy can give priority to certain activities over processing received push messages. For example, if the client device 102 is experiencing high CPU or memory usage by an application that is focused by the user, priority can be granted to that foreground activity and lower priority be given to a background activity responsible for handling received push messages, and so on.

Based on the assessment made by the OS-level handler 602, processing of the received push message can proceed to operation 512 to generate a push notification, or to operation 522 to buffer the received push message.

### Generate Push Notification

At operation 512, the client device 102 can process the received push message by dispatching an event to generate a push notification (data flow D). In accordance with some embodiments of the present disclosure, the OS-level handler 602 can launch an application-level web push event handler 116 to handle the received push message. The specific web push message handler 116 that is launched can be determined based on the push channel associated with the received push message. In some embodiments, for example, a mapping or similar information can be maintained in the operating system 114 that maps push channels with web push message handlers. The OS-level handler 602 can use the mapping information to launch a suitable application-level handler.

The web push message handler 116 can be any suitable web application configured to process a push message, either by being hard coded or via a script. In some embodiments, for example, the web push message handler 116 can be a service worker process that runs a service worker script, such as described above in connection with FIG. 4. In general, the specific web push message handler 116 associated with a given push channel can be any suitable application-level web application.

For example, suppose as shown in FIGS. 3 and 4, that the push subscription was created by service worker 406, launched by a web browser 402 or other web application. In accordance with the present disclosure, a different instance of the same service worker script can run in the background to process push messages. By launching a separate instance of the service worker script in the background, we guarantee that the lifetime of the background script is not tied to that of the browser or app. Accordingly, if the browser or app is closed by the user, crashes, or otherwise stops executing while the background script is processing a push event, that event will continue to be processed since the background script is not tied to the lifetime of that browser or app.

At operation 514, the client device 102 can generate a suitable push notification to alert the user 10. In some embodiments, for example, the web push message handler 116 can present a notification on the client device 102. In a simple case, the push notification can be a pop-up message that appears on the display (data flow E).

### Buffer Push Notification

At operation 522, the client device 102 can process the received push notification by buffering it. If at operation 508, the OS-level handler 602 determines not to generate a push notification, the OS-level handler 602 can buffer the received push message for later consumption. In some embodiments, for example, the client device 102 may have a notification facility for storing various kinds of notifications. The Microsoft® Action Center, for example, is a notification center used in various Microsoft® Windows™ operating systems to display system notifications and provide quick access to various settings. The OS-level handler 602 can access such a notification facility to cache the received push message to be subsequently retrieved by the user 10 (data flow E, FIG. 6B).

At operation 524, client device 102 can process the buffered push message at a later time. In some embodiments, for example, the user 10 may see the buffered push message in the notification facility and take appropriate action. In other embodiments, the OS-level handler 602 can launch an application-level task at a later time to process the buffered push message; for example, when there are sufficient system resources (e.g., sufficient battery charge) to process the buffered push message.

For comparison purposes, FIG. 7 illustrates the data flow for processing a received push message in a conventional configuration. The data flow at A represents a push request sent by the web server 12 to the web push server 14. As explained above, the push request can include a push message encrypted using the message public key. The push message can be further encrypted using the web server private key to authenticate the web server 12 as the source of the message. The push channel can be included in the push request to the web push server 14 to identify the target of the push message.

The web push server 14 can verify that the received push message originated from the web server 12 using the web server public key. Data flow B represents a verified push message sent by the web push server 14 to the client device 102, and can include the push channel that identifies the target of the push message.

The push message is read by an application-level push client 702 (e.g., web browser) executing on the client device 102. For example, the push client 702 can set up a TCP/IP connection 122 to read messages from the web push server 14. It is noted here that the push client 702 itself reads messages from the web push server 14. Accordingly, if the push client 702 is no longer executing on the client device 102 (i.e., the process had been terminated subsequent to setting up the push channel), then any push messages that the web push server 14 sends to client device 102 will not be processed (e.g., no notification will be generated) and will be essentially lost.

In response to receiving the push message, the push client 702 can launch (data flow C) a child process (e.g., service worker 704) to process the received push message (data flow D). The particular service worker that the push client 702 launches can be determined based on the push channel identified in the received push message. The service worker 704 can generate and present a suitable web push notification 18 to the user 10 (data flow E). In some instances, for example, the notification 18 can appear on a webpage 704 that the user 10 is viewing. In other instances, the notification 18 can appear as a pop-up message, if the push client 702 is executing as an application-level background task.

Referring back to FIGS. 5, 6A, and 6B in connection with operation 508, in accordance with the present disclosure, the OS-level handler 602 can assess the impact on the client device 102 of generating a push notification to process a received push message. If processing a received push message involves simply displaying a notification, this may not have much impact on the client device 102. On the other hand, if processing a received push message requires more system resources, then system performance may be impacted. For example, handling the push message may involve downloading large amounts of data such as news articles, emails with attachments, and so forth, which can consume considerable system resources of the client device 102. Accordingly, a closer assessment of available system resources may be appropriate in certain cases.

In some embodiments, the OS-level handler 602 can make an assessment of current process load on the client device 102 using a process table in the OS of all the processes executing on the client device 102. The OS-level handler 602 can take into consideration factors such as the number or processes executing on the client device 102, which processes are idle or executing, which processes have high priority, and so on. The OS-level handler 602 can assess whether launching the web push message handler 116 will have negative impact on existing processes executing on the client device 102. In the case of a portable client device 102, the number of executing processes can provide a measure of battery usage and thus can serve as a basis for whether or not to launch the web push message handler 116 to generate a push notification for the received push message or to buffer the received push message.

In some instances, the OS-level handler 602 can determine if sufficient resources are available. The OS-level handler 602, for example, can make an assessment based on memory usage of the client device 102. Since the OS-level handler 602 is an OS-level process, it has knowledge of the memory usage of every other process executing on the client device 102 and can reason about the memory usage patterns of the other processes. A web push message handler that consumes significant memory may not be suitable in a given situation.

By comparison with the conventional processing of a push notification shown in FIG. 7, the application-level push client (e.g., browser 702) can only be aware of its own process space. As such the push client will process a received push message irrespective of other activities on client device 102, which can affect other processes by competing for system resources to process the push message.

The above description illustrates various embodiments of the present disclosure along with examples of how aspects of these embodiments may be implemented. The above examples and embodiments should not be deemed to be the only embodiments, and are presented to illustrate the flexibility and advantages of the present disclosure as defined by the following claims. For example, although certain embodiments have been described with respect to particular process flows and steps, it should be apparent to those skilled in the art that the scope of the present disclosure is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the present disclosure as set forth in the following claims.

What is claimed is:

1. An apparatus comprising:
one or more computer processors; and
a computer-readable storage medium having stored thereon computer-executable instructions for an operating system level (OS-level) task that executes in an operating system of the apparatus,
the OS-level task for controlling the one or more computer processors to:
receive a web push message from a push server that originates from a web site; and
in response to receiving the web push message, make an assessment whether to (i) launch a first application-level process to generate a notification of the web push message or (ii) buffer the web push message instead of launching the first application-level process.

2. The apparatus of claim 1, further comprising the OS-level task controlling the one or more computer processors to:
make the assessment based on availability of computing resources on the apparatus including assessing one or more of processing load of processes executing on the apparatus and memory usage by the processes executing on the apparatus; and
based on an assessed availability of computing resources on the apparatus, select between (i) launching the first application-level process and (ii) buffering the web push message instead of launching the first application-level process.

3. The apparatus of claim 1, further comprising the OS-level task controlling the one or more computer processors to make the assessment based on a policy.

4. The apparatus of claim 1, further comprising the OS-level task controlling the one or more computer processors to:
receive a push subscription request from a second application-level process to create a push subscription; and
in response to receiving the push subscription request, communicate the push subscription request to the push server to create the push subscription thereby enabling the web site to send web push messages to the apparatus.

5. The apparatus of claim 4, wherein the first application-level process is not a child process of the second application-level process.

6. The apparatus of claim 4, wherein the second application-level task terminates prior to the OS-level task receiving the web push message from the push server.

7. The apparatus of claim 1, further comprising the OS-level task controlling the one or more computer processors to launch the first application-level process to process the web push message at a time subsequent to buffering the web push message.

8. The apparatus of claim 1, wherein the first and second application-level processes are web applications implemented using Web technologies.

9. A computer-readable storage medium having stored thereon computer executable instructions, which when executed by a computer device, cause the computer device to execute an operating system level (OS-level) task in an operating system of the computer device, wherein the OS-level task:
receives a web push message from a push server that originates from a web site; and
in response to receiving the web push message, makes an assessment whether to (i) launch a first application-level process to generate a notification of the web push message or (ii) buffer the web push message instead of launching the first application-level process.

10. The computer-readable storage medium of claim 9, wherein the OS-level task further:
makes the assessment based on availability of computing resources on the computer device including assessing one or more of processing load of processes executing on the computer device and memory usage by the processes executing on the computer device; and
based on an assessed availability of computing resources on the computer device, selects between (i) launching the first application-level process and (ii) buffering the web push message instead of launching the first application-level process.

11. The computer-readable storage medium of claim 9, wherein the OS-level task further makes the assessment based on a policy.

12. The computer-readable storage medium of claim 9, wherein the OS-level task further:
receives a push subscription request from a second application-level process to create a push subscription; and
in response to receiving the push subscription request, communicates the push subscription request to the push server to create the push subscription thereby enabling the web site to send web push messages to the computer device.

13. The computer-readable storage medium of claim 12, wherein the first application-level process is not a child process of the second application-level process.

14. The computer-readable storage medium of claim 12, wherein the second application-level task terminates prior to the OS-level task receiving the web push message from the push server.

15. The computer-readable storage medium of claim 9, wherein the OS-level task further launches the first application-level process to process the web push message at a time subsequent to buffering the web push message.

16. A method for an operating system level (OS-level) task executing in the operating system of a client device, the method comprising the OS-level task performing operations including:
receiving a web push message from a push server that originates from a web site; and
in response to receiving the web push message, making an assessment whether to (i) launch a first application-level process to generate a notification of the web push message or (ii) buffer the web push message instead of launching the first application-level process.

17. The method of claim 16, further comprising the OS-level task:
making the assessment based on availability of computing resources on the client device including assessing one or more of processing load of processes executing on the client device and memory usage by the processes executing on the client device; and
based on an assessed availability of computing resources on the client device, selecting between (i) launching the first application-level process and (ii) buffering the web push message instead of launching the first application-level process.

18. The method of claim 16, further comprising the OS-level task making the assessment based on a policy.

19. The method of claim 16, further comprising the OS-level task:
receiving a push subscription request from a second application-level process to create a push subscription; and
in response to receiving the push subscription request, communicating the push subscription request to the push server to create the push subscription thereby enabling the web site to send web push messages to the client device.

20. The method of claim 19, wherein the first application-level process is not a child process of the second application-level process.
